(19) United States
(12) Patent Application Publication
(10) Pub. No.: US 2007/0157593 A1
(43) Pub. Date: Jul. 12, 2007

(54) Double action rake

(76) Inventor: Manon Belanger, Blainville (CA)

Correspondence Address: INVENTARIUM;Suite 1607, 4050 Rosemont Blvd., Montreal, QC, H1X 1M4, CA

(21) Appl. No.: 11/651,741

(22) Filed: Jan. 9, 2007

Related U.S. Application Data
(60) Provisional application No. 60/757,318, filed on Jan. 9, 2006.

(51) Int. Cl. A01D 7/00

(52) U.S. Cl. 56/400.16

(57) ABSTRACT

A double action rake has a rake part composed of tines attached to a handle, and a set of secondary tines passing through a comb The secondary set of tines is attached to a slider which is itself attached to a rod. The rod, in turn is attached to the handle by an attachment bracket. A locking means locks and unlocks the slider and the comb is fixedly attached to the rod.

### FIELD OF THE INVENTION

The invention relates generally to landscaping tools but more particularly to a rake combining two rakes in one.

### BACKGROUND OF THE INVENTION

### PRIOR ART CAPABILITY AND MOTIVATIONS, AS HELPING TO SHOW PATENTABILITY HERE

Even in hindsight consideration of the present invention to determine its inventive and novel nature, it is not only conceded but emphasized that the prior art had many details usable in this invention, but only if the prior art had had the guidance of the present invention, details of both capability and motivation.

That is, it is emphasized that the prior art had/or knew several particulars which individually and accumulatively show the non-obviousness of this combination invention. E.g.,
a) The cost of the materials are relatively low and do not have a profound impact on price to the point of offsetting the benefits of this novel product;
b) The nature of an invention as being a “novel combination”, in spite of existence of details separately, is especially significant here where the novelty is of the plurality of concepts, i.e., the use of extendible tines in combination with a rake creates a new functionality unachievable by using two separate types of rakes and therefore a synergistic effect is obtained;
c) The addition of providing the extendible tines that are more rigid and configured narrowly allows the rake to reach hard to reach areas only when needed and leaves the rake to operate as a standard rake the rest of the time;
d) The matter of particular cost-factors, when considering that one rake can not only replace two rakes but can do things that a simple aggregation of rake can do because they could not physicaly be incorporated in a manner taught by this invention;
e) The matter of practicality in having a device already modified adapted and conceived in an original and non-obvious way so as to achieve the desired result;
f) The ease of tooling for the present invention has surely given manufacturers ample incentive to have made modifications for commercial competitiveness in a competitive industry, if the concepts had been obvious;
g) The prior art has always had sufficient skill to make many types of extendible tines interlaced with a secondary rake and which act like a hand to push up low hanging branches from bushes, more than ample skill to have achieved the present invention, but only if the concepts and their combinations had been conceived;
h) Substantially all of the operational characteristics and advantages of details of the present invention, when considered separately from one another and when considered separately from the present invention's details and accomplishment of the details, are within the skill of persons of various arts, but only when considered away from the integrated and novel combination of concepts which by their cooperative combination achieve this advantageous invention;
i) The details of the present invention, when considered solely from the standpoint of construction, are exceedingly simple, basically adding a lever and attachment means for a set of movable tines to a rake otherwise manufactured using methods known in the art and the matter of simplicity of construction has long been recognized as indicative of inventive creativity;
j) Similarly, and a long-recognized indication of inventiveness of a novel combination, is the realistic principle that a person of ordinary skill in the art, as illustrated with respect to the claimed combination as differing in the stated respects from the prior art both as to construction and concept, is presumed to be one who thinks along the line of conventional wisdom in the art and is not one who undertakes to innovate; and
k) The predictable benefits from a novel product and method of use having the features of this invention would seem sufficiently high that others would have been working on this type of product, but only if the concepts which it presents had been conceived.

Accordingly, although the prior art has had capability and motivation, amply sufficient to presumably give incentive to the development a product and method of use according to the present invention, the fact remains that this invention awaited the creativity and inventive discovery of the present Inventor. In spite of ample motivation, the prior art did not suggest this invention.

### PRIOR ART AS PARTICULAR INSTANCES OF FAILURE TO PROVIDE THIS NOVEL PRODUCT AND INSTALLATION METHOD

In view of the general practical advantages of the present invention as an improved embodiment of the prior art, it may be difficult to realize that the prior art has not conceived of the combination purpose and achievement of the present invention, even though the need for it is a known requested commodity for people nowadays who do not want to spend too much time and effort in doing the chore that is raking leaves and cleaning up their yard. Surely the need for a practical rake that facilitate the chore of raking has been known for decades and the technology to achieve such results has been known for years and that the various combination provided in this invention would have been desired and attempted long ago, but only if its factors and combination-nature had been obvious.

Other considerations, as herein mentioned, when realistically evaluated show the inventive nature of the present invention, a change in concept which the prior patent and other prior art did not achieve.

### SUMMARY OF THE PRIOR ART'S LACK OF SUGGESTIONS OF THE CONCEPTS OF THE INVENTION'S COMBINATION

And the existence of such prior art knowledge and related ideas embodying such various features is not only conceded, it is emphasized; for as to the novelty here of the combination, of the invention as considered as a whole, a contrast to the prior art helps also to remind of needed improvement, and the advantages and the inventive significance of the present concepts. Thus, as shown herein as a contrast to all the prior art, the inventive significance of the present concepts as a combination is emphasized, and the nature of the concepts and their results can perhaps be easier seen as an invention.

Although varieties of prior art are conceded, and ample motivation is shown, and full capability in the prior art is conceded, no prior art shows or suggests details of the overall combination of the present invention, as is the proper and accepted way of considering the inventiveness nature of the concepts.

That is, although the prior art may show an approach to the overall invention, it is determinatively significant that none of the prior art shows the novel and advantageous concepts in combination, which provides the merits of this invention, even though certain details are shown separately from this accomplishment as a combination.

And the prior art's lack of an invention of a double action rake and other advantages of the present invention, which are goals only approached by the prior art, must be recognized as being a long-felt need now fulfilled.

Accordingly, the various concepts and components are conceded and emphasized to have been widely known in the prior art as to various installations; nevertheless, the prior art not having had the particular combination of concepts and details as here presented and shown in novel combination different from the prior art and its suggestions, even only a fair amount of realistic humility, to avoid consideration of this invention improperly by hindsight, requires the concepts and achievements here to be realistically viewed as a novel combination, inventive in nature. And especially is this a realistic consideration when viewed from the position of a person of ordinary skill in this art at the time of this invention, and without trying to reconstruct this invention from the prior art without use of hindsight toward particulars not suggested by the prior art.

### FEATURES AND ADVANTAGES OF THE INVENTION

### SUMMARY OF THE INVENTION

In view of the foregoing disadvantages inherent in the known devices now present in the prior art, the present invention, which will be described subsequently in greater detail, is to provide objects and advantages which are to provide for a standard rake having extendible tines interlaced with the main rake and which act like a hand to push up low hanging branches from bushes. Lifting the branches allows the rake to easily reach heretofore unreachable areas.

To attain these ends, the present invention generally comprises a rake part composed of tines attached to a handle, and a set of secondary tines passing through a comb The secondary set of tines is attached to a slider which is itself attached to a rod. The rod, in turn is attached to the handle by an attachment bracket. A locking means locks and unlocks the slider and the comb is fixedly attached to the rod.

In use, an intended user rakes leaves and/or related debris as is known in the art by using the regular tines when the secondary tines are retracted. Then, as required, the intended user unlocks the locking means and slides the slider along the rod so as to protract the secondary tines. Of course the process can be reversed to bring the double action rake back to its initial configuration.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Top view of the rake retracted.

FIG. 2 Side view of the rake retracted.

FIG. 3 Top view of the rake protracted.

### DETAILED DESCRIPTION

A double action rake (10) has a rake part (12) composed of tines (14) attached to a handle (16). The aforementioned rake part (12) refers to a rake construction similar to what is generally known in the art of leaf rakes. A set of secondary tines (18) pass through a comb (20) and all the secondary tines (18) are attached to a slider (24) which slides along a rod (22). The comb (20) is set perpendicular and is fixedly attached to the rod (22). The rod (22) is attached to the handle (16) by way of an attachment bracket (28). The secondary tines (18) are generally more centered in relation to the tines (14) so as to effect a more concentrated raking action to thoroughly clean small tight spots while the tines (14) push up the branches of the shrubs and bush that would otherwise get in the way.

The comb (20) has a plurality of openings (not shown) that allow the passage of the secondary tines (18) therethrough. This element is similar to that of adjustable rakes and need not be further discussed herein.

A locking means (30) locks and unlocks the slider (24) so that it can slide along the rod (22). This sliding motion is what allows the secondary set of tines (18) to retract or protract. The locking means can be taken from any of a variety of mechanical configuration which are known in various art wherein a sliding motion has to be allowed or impeded. As such, it need not be further discussed herein.

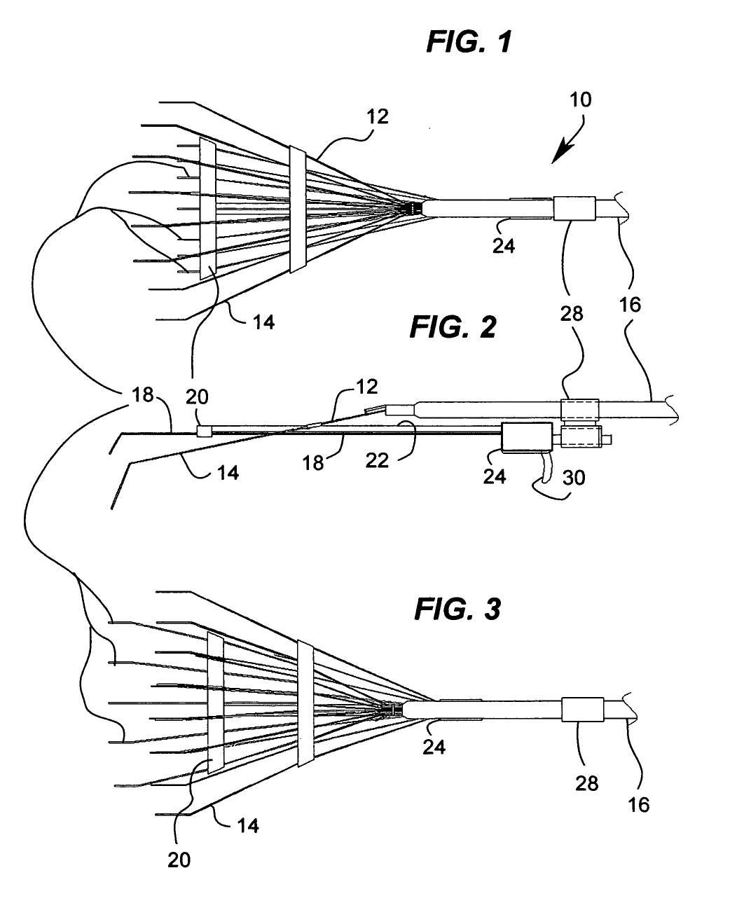

In use, an intended user rakes leaves and/or related debris as is known in the art by using the regular tines (14) in a configuration as per FIGS. 1-2 which is the retracted configuration. When confronted with a hard to reach spot such as underneath a hedge for example, the intended user unlocks the locking means (30) and slides the slider (24) along the rod (22) so as to protract the secondary tines (18) into a configuration as per FIG. 3. In doing so, the regular tines (14), being on top of the secondary tines (18), push on branches or like impediments and allow for the double action rake (10) an extended reach. When this configuration is no longer required, the intended user can of course reverse the process and bring retract the secondary tines (18) to the configuration as per FIGS. 1-2.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A double action rake comprising:
a rake part composed of tines attached to a handle;
a set of secondary tines passing through a comb;
said secondary set of tines being attached to a slider;
said slider slidingly attached to a rod;
said rod being attached to said handle by an attachment bracket;
a locking means to lock and unlock said slider;
said comb being fixedly attached to said rod.

2. A double action rake as in claim 1 having the following method of use:
an intended user rakes leaves and/or related debris as is known in the
art by using said regular tines when said secondary tines are retracted;
said intended user, as required, unlocks said locking means and slides
said slider along said rod so as to protract said secondary tines;
said intended user can reverse the process to retract said secondary tines.
